(19) United States
(12) Patent Application Publication
(10) Pub. No.: US 2001/0031041 A1
(43) Pub. Date: Oct. 18, 2001

(54) Call recording device for recording important messages

(76) Inventor: Bruce W. H. Sun, Taipei (TW)

Correspondence Address: Dougherty & Troxell, ONE SKYLINE PLACE, SUITE 1404, 5205 LEESBURG PIKE, FALLS CHURCH, VA, 22041, US

(21) Appl. No.: 09/794,281

(22) Filed: Feb. 28, 2001

(30) Foreign Application Priority Data
Mar. 17, 1999 (TW) 088204005

(51) Int. Cl. H04M 1/64

(52) U.S. Cl. 379/67.1; 379/88.22

(57) ABSTRACT

A call recording device comprises a central processing unit (CPU) and a memory partitioned into a received message temporary area and a received message storage area. Under the control of CPU, when telephone is off hook the call is digitized and stored into received message temporary area immediately. The received message temporary area is capable of storing one or more calls. User may press a button on the device before or during the period of call or immediately after the call for recording an important message. User may also input a archieve code into a dual tone multifrequency (DTMF) telephone for moving the recorded call in received message temporary area to received message storage area. Calls recorded in the device are maintained integrally such that a call prior to recording may be not lost.

### BACKGROUND OF THE INVENTION

1. Field of the Invention

The present invention relates to call recording machines and more particularly to a call recording device for recording important messages without a miss.

2. Description of Related Art

Conventionally, call answering/recording devices are classified as personal use ones, such as phone recorders and digital call answering machines and corporate use ones. As to phone recorder, in operation first press a record button to activate the recorder. Typically, the user only presses a RECORD button to save a message when he/she feels that the message is important, however, the prior messages are lost. As to digital call answering machine, it is mainly used as a means for recording messages of callers. It may also be used as call recorder. It has the same drawback as the phone recorder. But the digital call answering machine is advantageous over the phone recorder because digitized memory is used in the former. This means that the recording and playing of recorded messages in the former is much faster than that in the latter.

As to corporate use call recording system installed in a company, bank, security firm, etc., it usually has a very large memory space such as hard disk, digital audio tape (DAT), magneto-optical (MO) drive, or the like. Typically, the recording length thereof is at the order of several thousand hours. Also, the system is capable of coupling to more than a thousand telephone lines. In the implementation, all incoming calls are recorded irrespective of the importance or not. The calls are recorded in DAT or MO drive automatically. Such system is expensive. Further, qualified trained persons are required to perform the daily operation and maintenance.

In view of above, the features of the personal use one are limited memory, cheap, and incapable of recording the total contents of a call (i.e., only message after the record button is pressed). As to the features of the corporate use call recording system are expensive (thus inhibiting personal purchase), total recording of calls (most of which are unimportant), and inconvenience in use. Thus, it is desirable to provide a novel and improved call recording device in order to overcome the above drawbacks of prior art.

### SUMMARY OF THE INVENTION

It is an object of the present invention to provide a convenient and user satisfying call recording device comprising a central processing unit (CPU) and a memory. Memory is partitioned into two areas wherein one is received message temporary area and the other is received message storage area. Under the control of CPU, when telephone is off hook the call is digitized and stored into received message temporary area immediately. The received message temporary area is capable of storing one or more calls. User may press a button on the call recording device before or during the period of call or immediately after the call for recording an important message. User may also input a archieve code into a dual tone multifrequency (DTMF) telephone for moving the recorded call in received message temporary area to received message storage area under the control of CPU. Calls recorded in the call recording device are well maintained such that a call prior to recording may be not lost.

It is another object of the present invention to provide a convenient and user satisfying call recording device wherein call files recorded in received message temporary area may be automatically deleted by system depending on applications. For example, those unsaved call files may be deleted when a next call is coming, a predetermined time has been elapsed since recording, or the oldest call file is replaced by a new call file when the number of call files has reached a maximum value. Hence, memory is always prepared for storing a next call. In this manner, there is no need to replace tape or worry about memory full as experienced in prior art. Alternatively, user may conveniently press a button on call recording device or input a predetermined delete code on a DTMF telephone to manually delete an immediately recorded call file.

It is still another object of the present invention to provide a convenient and user satisfying call recording device wherein user may conveniently press a button on call recording device or input a predetermined playback code on a DTMF telephone for listening an immediately recorded call file.

It is yet another object of the present invention to provide a convenient and user satisfying call recording device wherein user may conveniently press a button on a coupled DTMF based telephone to input an archieve code for saving a call, input a delete code for deleting the call, input a play back code for playing an immediately recorded call, or input a password code for listening all call files recorded in the received message storage area. Alternatively, user may listen call files stored in received message temporary area and search, maintain, delete and process with respect to the call files. Further, user may program various features, parameters, passwords, archieve code, delete code, and playback code and partition memory.

It is a further object of the present invention to provide a convenient and user satisfying call recording device wherein a plurality of groups each including buttons on call recording device or input codes of telephone set such as archieve button, archieve code, playback button, playback code, password, etc. may be formed. Each group is belonged to an individual such that multiple users may use the same group device. For example, when a plurality of people use telephones, operator may press a archieve button or input an archieve code through telephone set for immediately saving a call after finishing with the permission of the calling party. The saved call is stored in received message storage area such that the user may listen to it later. This has the benefits of reducing cost, saving space, and increasing applicable fields.

It is still further object of the present invention to provide a convenient and user satisfying call recording device wherein a plurality of telephone lines are coupled such that the plurality of telephone lines may be enabled by the same device. This is a multi user device and is suitable to business oriented services.

It is still further object of the present invention to provide a convenient and user satisfying call recording device which is possible of being activated by a remote telephone and the DTMF telephone is possible of being activated by the remote telephone for achieving the same effect as the one installed in house.

To achieve the above and other objects, the present invention provides a call recording device comprising a central processing unit (CPU) for monitoring all circuits and managing memory, a telephone interface circuit serially or parallel connected to telephone line and telephone set, a digital to analog/analog to digital converter (CODEC), a digital signal processor (DSP) coupled to CODEC and CPU, and a memory coupled to and controlled by CPU. Telephone interface circuit acts to receive calls, DTMF signals, and various control and identification signals on telephone line such as on/off hook, ring, busy, and response signals. The converted signals by CODEC are sent to CPU or directly sent to pins of CPU. When a call is established, CPU may immediately record after a signal sent from telephone interface circuit indicating the establishment. Then the call is transmitted through telephone interface circuit and CODEC for converting into digital signals. The converted signals are further sent to CPU for processing prior to storing in memory. User may press a button on the call recording device or input an archieve code through DTMF buttons on telephone set before or during the period of call or immediately after the call for recording an important message without a miss.

It is important to note that the above received message temporary area and received message storage area are virtual not physical devices. They are formed simply for classifying a call file as temporary and permanent ones. The temporary one means that the call file may be deleted automatically when a certain condition is met. In comparison, the permanent one means that the call file is deleted only when user instructs so or a delete condition set by user is met. Such received message temporary area and received message storage area may coexist in memory under the control of memory management program. This does not mean that physical received message temporary area and received message storage area are required to exist in memory. Likewise, the transfer of a call file in received message temporary area to received message storage area does not mean that a physical movement is required. To the contrary, it simply means that a label is required to append to the call file to be transferred by an instruction.

The above and other objects, features and advantages of the present invention will become apparent from the following detailed description taken with the accompanying drawings.

### BRIEF DESCRIPTION OF THE DRAWINGS

FIG. 1 is a block diagram of a first preferred embodiment of call recording device according to the invention;

FIG. 2 is a block diagram of a second preferred embodiment of call recording device according to the invention;

FIG. 3 is a block diagram of a third preferred embodiment of call recording device according to the invention;

FIG. 4 is a block diagram of a fourth preferred embodiment of call recording device according to the invention;

FIG. 5 is a detailed circuit diagram of a fifth preferred embodiment of call recording device according to the invention; and

FIG. 6 is a block diagram of a sixth preferred embodiment of call recording device according to the invention.

### DETAILED DESCRIPTION OF THE PREFERRED EMBODIMENTS

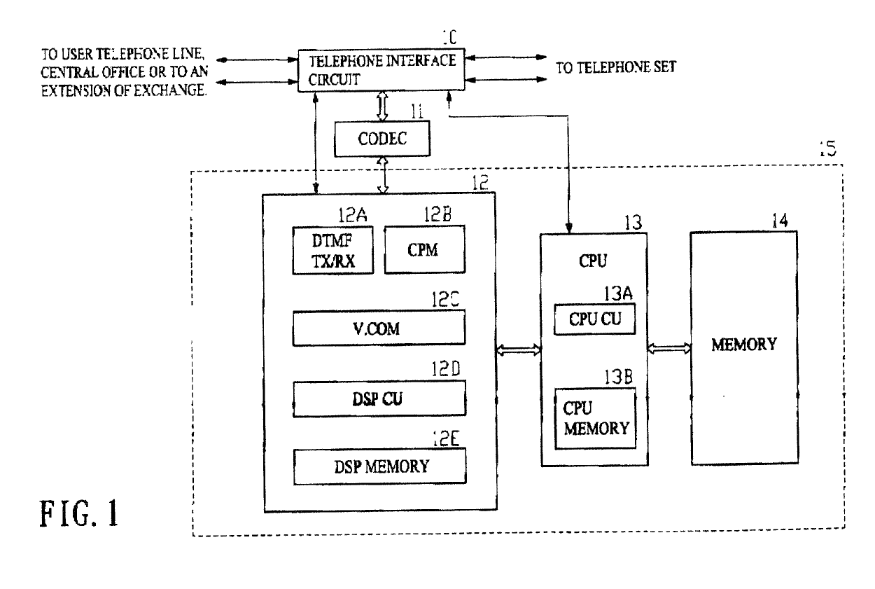

Referring to FIG. 1, there is shown a call recording device of a first preferred embodiment of call recording device according to the invention. The call recording device comprises a central processing unit (CPU) 13, a telephone interface circuit 10, a memory storage (memory) 14, a digital to analog/analog to digital converter (CODEC) 11, and a digital signal processor (DSP) 12. DSP 12 comprises a dual tone multifrequency transceiver (DTMF TX/RX) 12A, a call processing monitoring (CPM) unit 12B for detecting and generating a tone signal and a ring signal, a voice signal compression/decompression unit (V.COM) 12C, a control unit for executing programs in DSP (DSP CU) 12D, and a memory unit for storing programs and data in DSP (DSP memory) 12E. CPU 13 comprises a control unit for executing programs in CPU (CPU CU) 13A and a memory unit for storing programs and data in CPU (DSP memory) 13B. Telephone interface circuit 10 is coupled between a telephone line (e.g., user telephone line, central office, or an extension of exchange) and a telephone set. Call (or DTMF signal) coming from telephone or telephone line, or signal on telephone line (e.g., busy, ring, etc.) is sent to CODEC 11 for converting into digital signal through telephone interface circuit 10. The digital signal is then sent to DSP 12 for processing. At the same time, some signals are sent directly to a control pin of DSP 12, CPU 13, or DSP 12 and CPU 13.

DTMF TX/RX 12A of DSP memory 12E converts DTMF signals into digits prior to sending to CPU 13. CPU 13 then decodes the digits as archieve code, delete code, play code, password, or telephone operating code for control. V.COM 12C of DSP memory 12E compresses audio signal into a format prior to sending to CPU 13. CPU 13 then stores the digitized record signal in memory 14. In playing back received messages, CPU 13 receives an instruction from DSP 12 and decodes it. The decoded instruction is then sent to the memory 14 for reading a desired file of received message therefrom. The read out file is sent to DSP 12 for V.COM 12C to decompress. The compressed file is sent to CODEC 11 for converting into audio signals which are in turn sent to telephone interface circuit 10 for listening to receiving message. CPM 12B of DSP memory 12E identifies signals on telephone line as ring, busy, etc. For DSP and CPU to monitor in order to determine whether telephone has been hanged up. If yes, telephone interface circuit 10 is disconnected from telephone line (i.e., on hook).

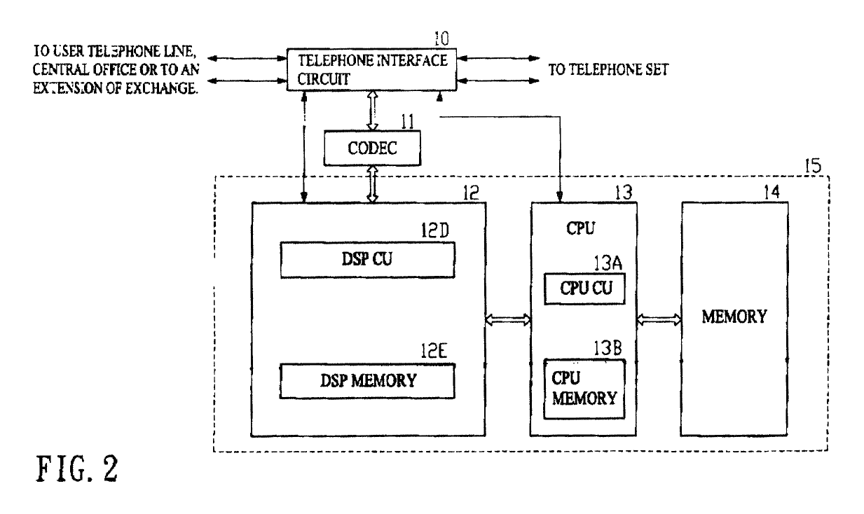

Referring to FIG. 2, there is shown a second preferred embodiment of call recording device according to the invention. The embodiment is substantially the same as the first one except the following: DTMF TX/RX 12A, CMP 12B, and V.COM 12C of DSP 12 are eliminated because DTFM telephone set is replaced by a plurality of buttons, ring checking function is not required, and compression/decompression of digital voice signal is replaced by directly storing into memory respectively. The same benefits are effected by the second embodiment.

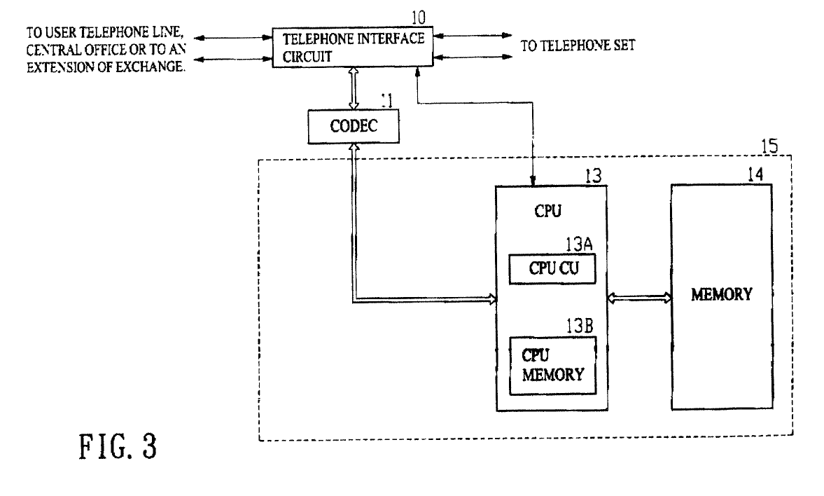

Referring to FIG. 3, there is shown a third preferred embodiment of call recording device according to the invention. The embodiment is substantially the same as the second one except the following: DSP 12 including DSP CU 12D and DSP memory 12E is eliminated. Hence, CODEC 11 is directly coupled to CPU 13. Thus CPU 13 may process signals sent from CODEC 11 or send signals back to CODEC 11. Further CPU 13 may send the processed signals to memory 14 to store or access data from memory 14.

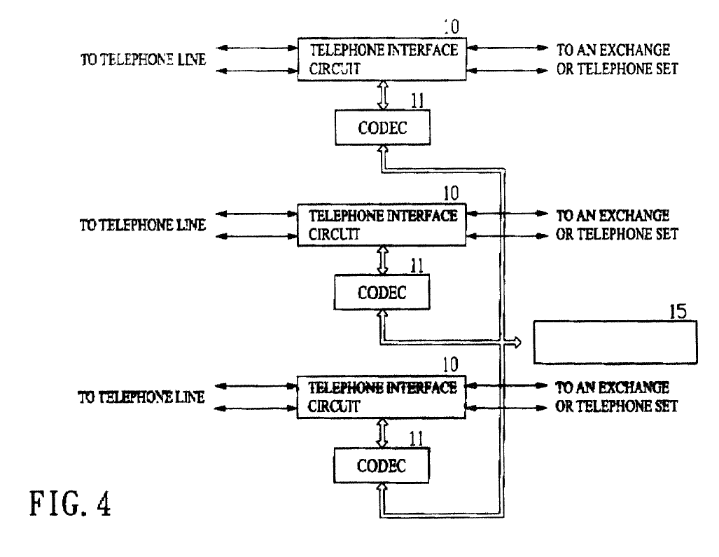

Referring to FIG. 4, there is shown a fourth preferred embodiment of call recording device according to the invention. In the embodiment, a plurality of telephone interface circuits (three are shown) 10 are provided. Telephone interface circuit 10 is coupled between two or more telephone lines and a telephone set (or exchange). CODEC 11 is coupled between telephone interface circuit 10 and block 15 of each of first, second, and third embodiments. The components of block 15 (not further shown) may control and process the variety of functions of telephone lines including recording.

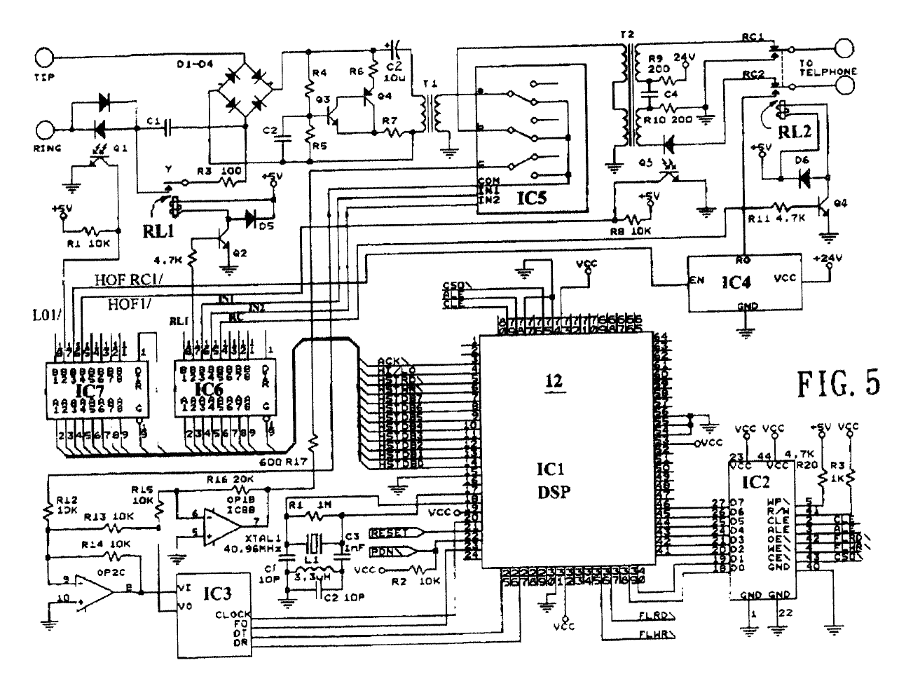

FIG. 5 is a detailed circuit diagram of a fifth preferred embodiment of call recording device according to the invention. As shown, IC1 DSP is equivalent to CPU and DSP in each of above embodiments. That is, CPU and DSP of above embodiments are incorporated and simplified as IC1 DSP. IC2 is a memory for storing a plurality of digitized files of received messages. IC2 is in data communication with IC1 DSP through pins DO to D7. IC6 is an output decoder for decoding control signals sent from IC1 and outputting the decoded signals in order to control the recording relay RL1, ring relay RL2, and analog contact IC5 of telephone interface circuit. IC7 is an input decoder for decoding ring signals sent from transistor Q1, recording signal from IC4, and on hook signal from transistor Q3 and sending the decoded signals to input pins of IC1 DSP for IC1 processing through IC7. Transistor Q1 is enabled when a ring signal from user telephone line is received. A low signal is detected in LO1/pin of IC1 DSP. After LO1/ring signal is detected by IC1 DSP, a high signal is sent simultaneously from RC pin of IC1 DSP for enabling relay RL2. Once relay RL2 enabled, a ring current is outputted from IC4 ring generator and sent to ground through contact RC2, telephone set, and contact RC1. When handset is lifted, an electrical circuit is formed for enabling transistor Q3. Then a HOF1/signal is sent from transistor Q3. IC1 DSP is informed that handset is lifted by the inputted IC4 ring current. An IC4 ring current generator circuit may detect a lifting of handset while ringing. Then a HOF RC1/signal is sent from the IC4 ring current generator circuit. IC1 DSP may detect handset has been lifted while ringing through HOF RC1/pin. Thereafter, relay RL1 is enabled by IC1 DSP for disabling relay RL2. Hence, a loop is formed between telephone and exchange for enabling a call. IC1 DSP may record through analog contacts a and b of IC5 and receive DTMF signals. IC1 DSP may also disables the recording through contact c of IC5 for transmitting voice to user telephone line or telephone set. Alternatively, IC1 DSP may communicate with user telephone line or telephone set through contact a or b of IC 5 respectively. IC3 CODEC converts analog signals into digital ones which in turn are compressed by IC1 DSP prior to sending to IC2 memory for storage. The programs of IC1 DSP are stored in an internal storage program memory thereof. Further, a plurality of temporary areas are provided in IC1 DSP for storing data or providing an operational capability.

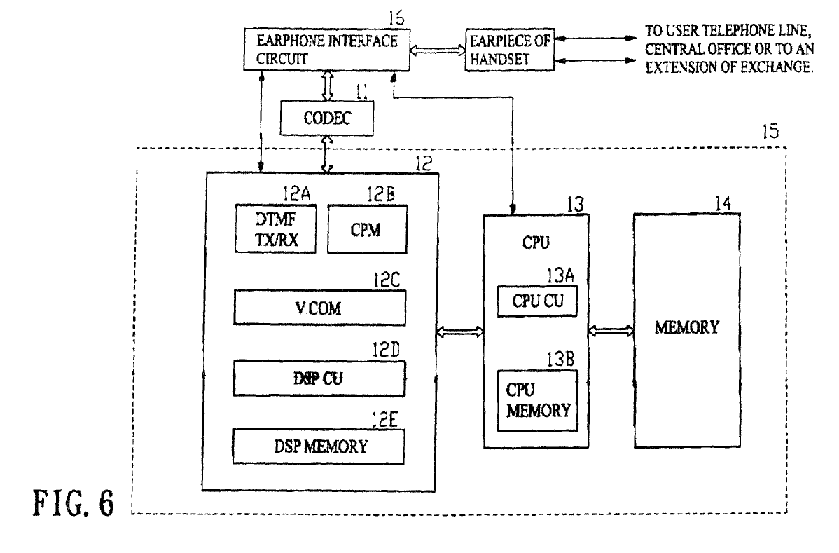

Referring to FIG. 6, there is shown a sixth preferred embodiment of call recording device according to the invention. In the embodiment, telephone interface circuit 10 of any above embodiments is replaced by earphone interface circuit 16. Earphone interface circuit 16 is coupled between an earpiece of handset and CODED 11. A signal sent from user telephone line or exchange to earpiece of handset is further sent to earphone interface circuit 16. CODEC 11 then converts the signal into digital form prior to sending to DSP 12 and CPU 13 sequentially. The processing in DSP 12 and CPU 13 is the same as that in the first embodiment. Thus a detailed description thereof is eliminated for the sake of brevity. Note that the sixth embodiment is applicable to digital telephone sets. That is, digital signal is a medium for communicating between telephone set and coupled user telephone line (or exchange). It is designed that the sixth embodiment is an alternative (i.e., earphone interface circuit 16) when connection between telephone set and coupled user telephone line (or exchange) is impossible in any of first to fifth embodiments.

It is noted that digital to analog converter 11, digital signal processor (DSP) 12, central processing unit (CPU) 13, and memory storage 14 may be altered, modified, or combined depending on applications. For example, each of digital signal processor 12 and central processing unit 13 may has memory for storing programs and data. Central processing unit 13 may be incorporated into DSP 12 for simplification of components. Alternatively, DSP may be eliminated leaving CPU alone. Moreover, memory may be any of semiconductor based memories such as SRAM, DRAM, ROM, EPROM, EEPROM, FLASH RAM, etc. Further, memory may be implemented as a single one or a combination of two or more semiconductor memories. Furthermore, memory 14 may be coupled to a device consisting of CPU and DSP, or both DSP and CPU. Memory may be separated from program memory and data temporary areas in CPU and DSP. Alternatively, memories may be combined to form externally/internally relative to CPU and DSP. Also, memory may have a configuration different from that mentioned above or memory may be formed of a material other than semiconductor.

In conclusion, as the technology of electronic industry progresses rapidly, all of above elements may be varied. For example, above elements and elements within CPU may be comprised of a plurality of individual elements. Or individual element may be comprised of a plurality of units. Further, a single element or a few elements of single functionality may be formed or combined from a variety of integrated circuits. Or a variety of features may be incorporated into different elements. Alternatively, add a few elements to obtain the same effect. While the invention herein disclosed has been described by means of specific embodiments, numerous modifications and variations could be made thereto by those skilled in the art without departing from the scope and spirit of the invention set forth in the claims.

What is claimed is:

1. A call recording device comprising:
a central processing unit (CPU) for monitoring all circuits and managing memory;
a telephone interface circuit serially or parallel connected to a telephone line and a telephone set;
a digital to analog/analog to digital converter (CODEC) coupled to said telephone interface circuit; and
a memory means coupled to and controlled by said CPU;
wherein said telephone interface circuit acts to receive calls, dual tone multifrequency transceiver (DTMF) signals, and various control and identification signals on said telephone line such as on/off hook, ring, busy, and response signals, said converted signals by said CODEC are sent to said CPU or directly sent to pins of said CPU, when a call is established, said CPU immediately records after a signal sent from said telephone interface circuit indicating said establishment, said call is transmitted through said telephone interface circuit and said CODEC for converting into digital signals, said converted signals are sent to said CPU for processing prior to storing in said memory means, and a button on said call recording device is operable to press or an archieve code through DTMF buttons on said telephone set is operable to input before or during said period of said call or immediately after said call for recording a message as a call file.

2. The call recording device of claim 1, wherein said recording of said call file is achieved by inputting said archieve code through said telephone set or by pressing said button on said call recording device.

3. The call recording device of claim 1, wherein said button on said call recording device is operable to press or a password through said DTMF buttons on said telephone set is operable to input for searching, listening, maintaining, deleting, and processing with respect to said call file, for programming a variety of functions, parameters, said archieve code, said delete code, said playback code, and password, and for partitioning said memory means.

4. The call recording device of claim 1, wherein said memory means and said memory of said CPU are separated or combined to form externally/internally relative to said CPU, and said memory means is formed of a variety of memory devices.

5. The call recording device of claim 1, wherein components and components within said CPU are implemented as a plurality of individual elements, each individual element is comprised of a plurality of units, a single element or a few elements of single functionality are formed or combined from a variety of integrated circuits, a variety of functionalities are incorporated into different components, or add a few elements to obtain said same effect.

6. A call recording device comprising:
a central processing unit (CPU) for monitoring all circuits and managing memory;
a telephone interface circuit serially or parallel connected to a telephone line and a telephone set;
a digital to analog/analog to digital converter (CODEC) coupled to said telephone interface circuit;
a digital signal processor (DSP) coupled to said CODEC and said CPU; and
a memory means coupled to and controlled by said CPU;
wherein said telephone interface circuit acts to receive calls, dual tone multifrequency transceiver (DTMF) signals, and various control and identification signals on said telephone line such as on/off hook, ring, busy, and response signals, said converted signals by said CODEC are sent to said DSP, a portion of said converted signals are directly sent to said DSP or said CPU, or said converted signals are directly sent to pins of said DSP or said CPU, when a call is established, said CPU immediately records after a signal sent from said telephone interface circuit indicating said establishment, said call is transmitted through said telephone interface circuit and said CODEC for converting into digital signals, said converted signals are sent to said DSP and said CPU for processing prior to storing in said memory means, and a button on said call recording device is operable to press or an archieve code through DTMF buttons on said telephone set is operable to input before or during said period of said call or immediately after said call for recording a message as a call file.

7. The call recording device of claim 6, wherein said DSP comprises a control unit (DSP CU) for executing programs in said DSP.

8. The call recording device of claim 6, wherein said DSP further comprises a DTMF TX/RX for detecting and generating a DTMF signal and a call processing monitoring (CPM) unit for detecting and generating a tone signal and a ring signal on said telephone line.

9. The call recording device of claim 6, wherein said DSP further comprises a voicesignal compression/decompression unit (V.COM) for compressing/decompressing said digital signal sent from said CODEC.

10. The call recording device of claim 6, wherein said CPU comprises a memory (CPU memory) for storing programs and data, said DSP comprises a memory (DSP memory) for storing programs and data, and said CPU further comprises a control unit (CPU CU) for executing programs in said CPU wherein said functionalities of said CPU memory and said CPU CU are combined in said DSP or said CPU memory and said CPU CU are combined into a single DSP means.

11. The call recording device of claim 6, wherein said memory means is one of a plurality of semiconductor based memories such as SRAM, DRAM, ROM, EPROM, EEPROM, and FLASH RAM and said memory means is implemented as a single semiconductor memory or a combination of two or more semiconductor memories.

12. The call recording device of claim 6, wherein said memory means is coupled to said CPU or said DSP or both said DSP and said CPU, and said CPU and said DSP are combined to form a means coupled to said memory means.

13. The call recording device of claim 6 wherein said DSP is replaced by said CPU.

14. The call recording device of claim 6, wherein said memory means and said memory of said CPU and said DSP are separated or combined to form externally/internally relative to said CPU and said DSP, and said memory means is formed of a variety of memory devices.

15. The call recording device of claim 6, wherein components and components within said DSP are implemented as a plurality of individual elements, each individual element is comprised of a plurality of units, a single element or a few elements of single functionality are formed or combined from a variety of integrated circuits, a variety of functionalities are incorporated into different components, or add a few elements to obtain said same effect.

16. A call recording device comprising:
a central processing unit (CPU) for monitoring all circuits and managing memory;
an earphone interface circuit coupled to an earpiece of a handset;
a digital to analog/analog to digital converter (CODEC) coupled to said earphone interface circuit; and
a memory means coupled to and controlled by said CPU;
wherein said earphone interface circuit acts to receive calls, dual tone multifrequency transceiver (DTMF) signals, and various control and identification signals on said telephone line such as on/off hook, ring, busy, and response signals, said converted signals by said CODEC are sent to said CPU or directly sent to pins of said CPU, when a call is established, said CPU immediately records after a signal sent from said earphone interface circuit indicating said establishment, said call is transmitted through said earphone interface circuit and said CODEC for converting into digital signals, said converted signals are sent to said CPU for processing prior to storing in said memory means, and a button on said call recording device is operable to press or an archieve code through DTMF buttons on said telephone set is operable to input before or during said period of said call or immediately after said call for recording a message as a call file.

17. The call recording device of claim 16, wherein said CPU comprises a memory for storing programs and data and a control unit (CPU CU) for executing said programs in said CPU.

18. The call recording device of claim 16, wherein said memory means and said memory of said CPU are separated or combined to form externally/internally relative to said CPU, and said memory means is formed of a variety of memory devices.

19. The call recording device of claim 16, further comprising a digital signal processor (DSP) coupled to said CODEC and said CPU wherein said earphone interface circuit acts to receive calls, DTMF signals, and various control and identification signals on said telephone line such as on/off hook, ring, busy, and response signals, said converted signals by said CODEC are sent to said DSP, a portion of said converted signals are directly sent to said DSP or said CPU, or said converted signals are directly sent to pins of said DSP or said CPU, when a call is established, said CPU immediately records after a signal sent from said earphone interface circuit indicating said establishment, said call is transmitted through said earphone interface circuit and said CODEC for converting into digital signals, said converted signals are sent to said DSP and said CPU for processing prior to storing in said memory means, and a button on said call recording device is operable to press or an archieve code through DTMF buttons on said telephone set is operable to input before or during said period of said call or immediately after said call for recording a message as a call file.

20. The call recording device of claim 19, wherein components and components within said DSP are implemented as a plurality of individual elements, each individual element is comprised of a plurality of units, a single element or a few elements of single functionality are formed or combined from a variety of integrated circuits, a variety of functionalities are incorporated into different components, or add a few elements to obtain said same effect.
